(19) United States
(12) Patent Application Publication
(10) Pub. No.: US 2011/0161410 A1
(43) Pub. Date: Jun. 30, 2011

(54) MASSIVE-SCALE INTERACTIVE VISUALIZATION OF DATA SPACES

(75) Inventors: GULJIT KHURANA, VIENNA, VA (US); HOA NGUYEN, LEESBURG, VA (US)

(73) Assignee: CENTRIFUGE SYSTEMS, INC., MCLEAN, VA (US)

(21) Appl. No.: 12/980,882

(22) Filed: Dec. 29, 2010

Related U.S. Application Data
(60) Provisional application No. 61/291,690, filed on Dec. 31, 2009.

(51) Int. Cl. G06F 15/16

(52) U.S. Cl. 709/203

(57) ABSTRACT

An improved system and method for rendering massive-scale interactive visualizations. A first aspect of the invention relates to server-based rendering of visualizations. A second aspect of the invention relates to dynamic element-based image animation.

### CROSS REFERENCE TO RELATED APPLICATION

This application claims the benefit under 35 USC 119(e) of U.S. Provisional Application No. 61/291,690, filed Dec. 31, 2009, the entirety of which is incorporated herein by reference.

### FIELD OF THE INVENTION

The invention relates to visualization of data spaces, including rendering and interacting with visualizations of data spaces on a massive scale.

### BACKGROUND

Information Analytics is the synthesis and comprehension of information to support decision making. This science encompasses areas such as Business Intelligence (BI) and Data Mining which provide tools for the visual analysis of data. These tools, often referred to as visualization products, render visual display entities that allow analysts to study, and understand the information.

Interactive visualization takes this one step further by allowing analysts to actually interact with the display entities (or visualizations) to pose follow-up questions and reach insights that are hidden within the data space. This interactivity requires that context be maintained for the individual elements in the visualization.

In the modern information landscape, the size of data repositories is exploding. This poses an enormous challenge for interactive visualizations where, for example, it is necessary to draw record-based elements that are individually accessible within the picture. In short, it has not been feasible to draw these sorts of diagrams at massive scale.

### SUMMARY

Embodiments of the invention provide an improved, and fundamentally different, system and method for rendering massive-scale interactive visualizations. A first aspect of the invention relates to server-based rendering of visualizations. A second aspect of the invention relates to dynamic element-based image animation.

The first aspect presents an approach to leveraging the computing resources of a server cloud to generate massive-scale data visualizations. The second aspect presents an unprecedented method for achieving full interactivity at the client workstation, which includes dynamically animating, or bringing to life, portions of an overall image that represent elements of interest. This is accomplished via frequent and fast exchanges with the server to determine what the user has expressed interest in and what needs to be animated as a result of the interaction.

### BRIEF DESCRIPTION OF THE DRAWINGS

FIG. 1 illustrates an example of a process for rendering visualization data.

FIG. 2 illustrates an example of a server cloud processing massive amounts of data to yield a result that is displayed on a map at a client workstation.

FIG. 3 illustrates an example of a server cloud processing massive amounts of data to yield a result that is displayed in a record-based visualization at a client workstation.

FIG. 4 illustrates an example of a process for providing interactive data visualization.

FIG. 5 illustrates an example of rendering visualization images in a server cloud.

FIG. 6 illustrates an example of an interactive visualization relating to people, places and flights.

FIG. 7 illustrates an example of a visualization depicting people, places and flights.

FIG. 8 illustrates an example of a dynamic element-based image animation.

### DETAILED DESCRIPTION

The invention is directed to an improvement in rendering massive-scale interactive visualizations. A first aspect of the invention relates to server-based rendering of visualizations. A second aspect of the invention relates to dynamic element-based image animation.

In connection with the first aspect of the invention, massive-scale interactive visualizations can be accomplished by employing server-based rendering of visualizations.

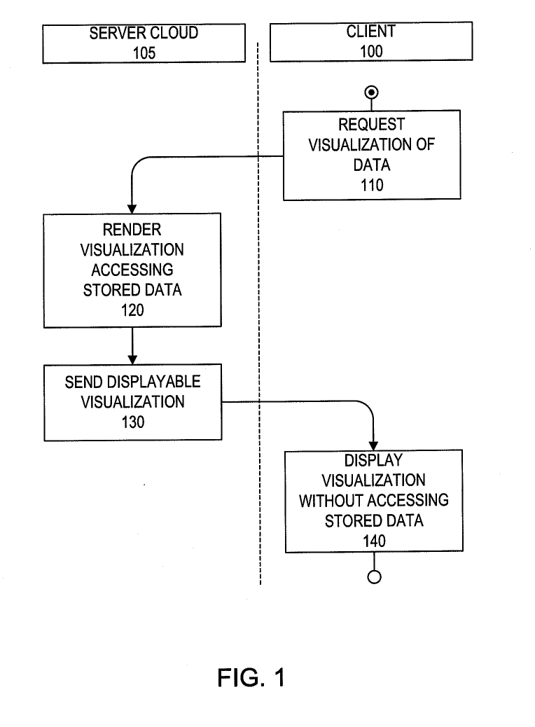

FIG. 1 illustrates an example of a process for rendering visualization data between client 100 and server cloud 110. In the embodiment illustrated in FIG. 1, a client computer (client 100) can request (block 110) a visualization of data from a server cloud (server cloud 105) comprising multiple server computers configured to operate together. The data can define any suitable data space, such as a relationship graph (i.e., multiple elements and a relationship between the multiple elements), a chart, a timeline, or a map for example. In response to the request, the server cloud can render (block 120) the requested visualization by accessing a data structure storing the data and processing the accessed data according to the request. The server cloud can then send (block 130) the rendered visualization to the client computer in a format displayable by the client computer without access to the data structure. Upon receiving the rendered visualization, the client computer can display (block 140) the rendered visualization without accessing the data structure.

This type of server-based rendering can be advantageously applied to organizations that operate large numbers of servers in a data center to provide computing resources for all of their information technology needs. These servers are often referred to as cluster or, increasingly today, a cloud. This server cluster allows organizations to align computing resources to particular information processing tasks on demand. That is, if a need for a particular task is spurious, more of the resources (servers) can be diverted to the task and then revert back to another task, or an idle state, when the task is complete.

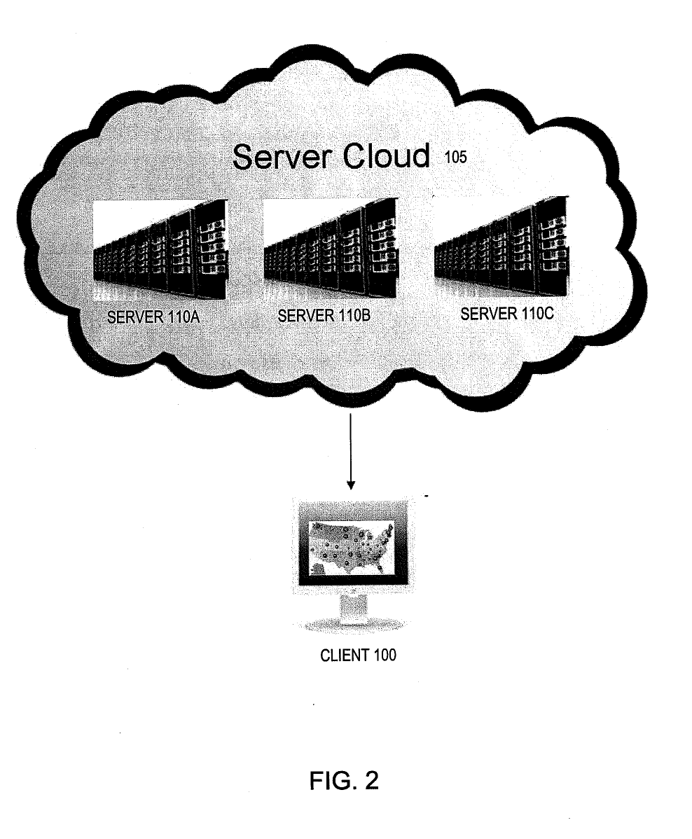

This model has proven effective for running algorithms against massive data repositories. For example, consider a database of tax payers at the IRS, and imagine a program that would run against this enormous database and calculate average incomes by state. This would represent a large computing task. To practically complete this sort of transaction, many servers would be assigned to the task. When complete, the result could be sent down to an analyst at their client workstation. FIG. 2 illustrates an example of a server cloud (105) processing massive amounts of data to yield a result that is displayed on a map at a client workstation (100).

Note that while the processing task above is very computationally intensive, the actual picture (the map) is not. In other words, the actual visualization that is rendered is the same regardless of the size of the underlying data. It will be a rendering of 50 states with a value for each one.

Consider a second problem and imagine a program that would run an algorithm that calculates each individual's retirement savings as a percentage of their income. However, rather than drawing a roll up at the state level, the drawing of an actual representation of each person is desired. This is a different class of visualization problem as now the actual picture that is rendered is dependent on the size of the underlying data. If there are 5 people in the database, there will be 5 nodes rendered in the graph. However, if there are 300 million, then 300 million actual nodes will need to be rendered in the picture. This class of visualization can be referred to as a node-based or record-based visualization.

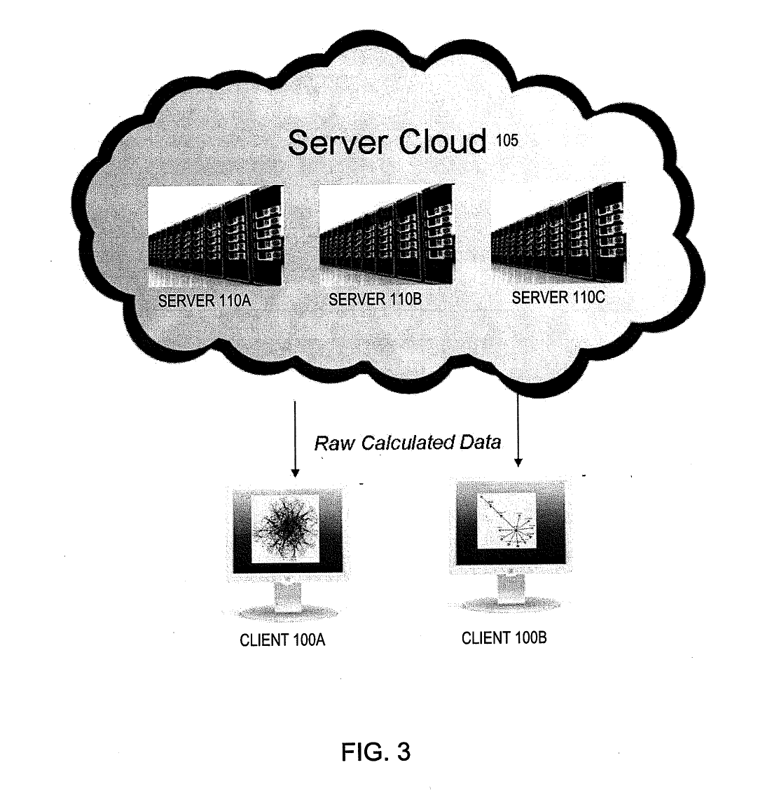

FIG. 3 illustrates an example of a server cloud processing massive amounts of data to yield a result that is displayed in a record-based visualization at a client workstation. FIG. 3 depicts two record-based visualizations. The one on the right depicts a handful of nodes. The one on the left has several thousand. The one on the left poses a more difficult rendering challenge. If one takes the number of nodes, or records in the underlying data source, up to millions, the problem becomes even more difficult.

Since the approach that is used in current methods involves rendering of the visualization on the client workstation, the pushing of the actual task of rendering the visualizations into the server cloud as disclosed in the invention takes advantage of an enormous amount of available computing resources that have not been leveraged to date for the intensive task of rendering.

Accordingly, the first aspect of the invention involves rendering the actual graph in the server cloud rather than the client display. The servers don't have to actually display the image; indeed servers are often referred to as “headless” meaning that no graphical display is attached. Rather, the servers are used for the CPU-intensive task of rendering the massive images. For example, since the rendering of the visualizations is a CPU-intensive task, the server cloud can represent significant processing resources that can be grown, or added, on demand. This means that the actual task of rendering can be divided and allocated amongst several computers or CPUs. As a result, the current method presents a significant advantage over the present limitation of performing all rendering on a single client computer.

In addition to rendering the picture (which is computationally intensive), the servers can also maintain the entire context of the image. That is, rather than just storing an image, the servers are aware of all of the elements in the picture, the corresponding data attached to each element, the properties, location, etc. For example, the server cloud can share the context for the entire visualization so that each computer or CPU in the server cloud has access to all relevant information about the visualization, including the locations of the individual elements as well as the data behind the rendered image for example.

After rendering, the server can simply sends an image for the client to display. This can be a relatively easy task for the client to perform. The difficult tasks of performing the rendering and maintaining the entire context can be offloaded to the cloud.

In connection with the second aspect of the invention, dynamic element-based image animation can be accomplished on the client via frequent and fast exchanges with the server to determine what portion of the displayed visualization the user has expressed interest in and what needs to be animated as a result of the interaction. In this manner, the client can employ not a static image but rather a fully interactive visualization. This enables a user to dynamically animate, or bring to life, portions of an overall image that represent elements of interest.

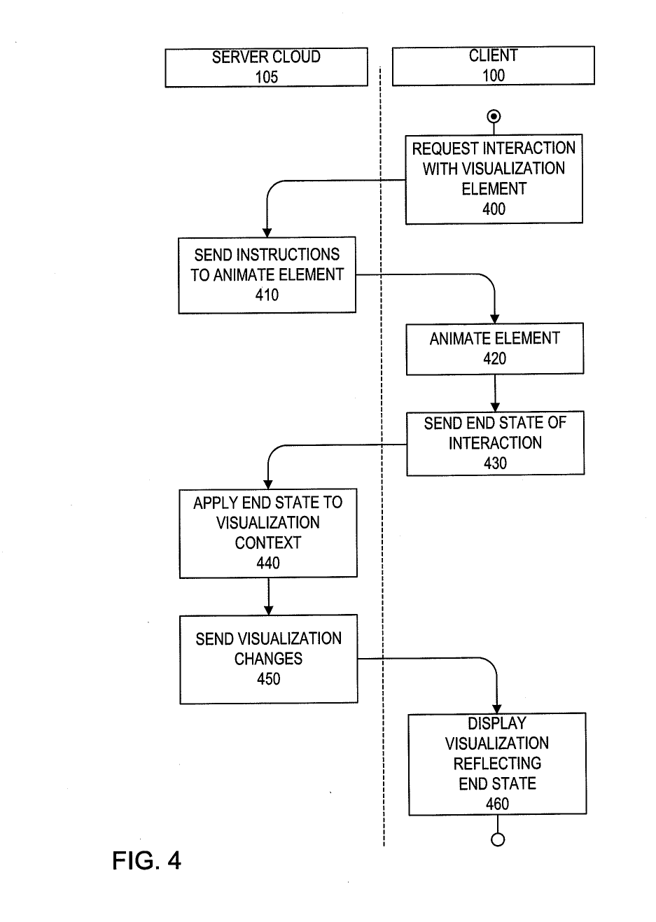

FIG. 4 illustrates an example of a process for providing interactive data visualization when the client is without the context for the visualization. In the embodiment illustrated in FIG. 4, the client computer can send (block 400) to a server computer a request for interaction associated with an element of a displayed visualization. In response, the server computer can send (block 410) to the client computer instructions to animate the element to achieve the interaction. The client computer can animate (block 420) the displayed visualization according to the received instructions and interaction provided by a user. When the user has completed the interaction, the client computer can send (block 430) an end state associated with the interaction to the server computer. In response, the server computer can apply (block 440) the end state to the stored context of the visualization in the cloud and send (block 450) to the client computer changes to the visualization to reflect the end state. Upon receiving the changes, the client computer can display (block 460) the visualization reflecting the end state.

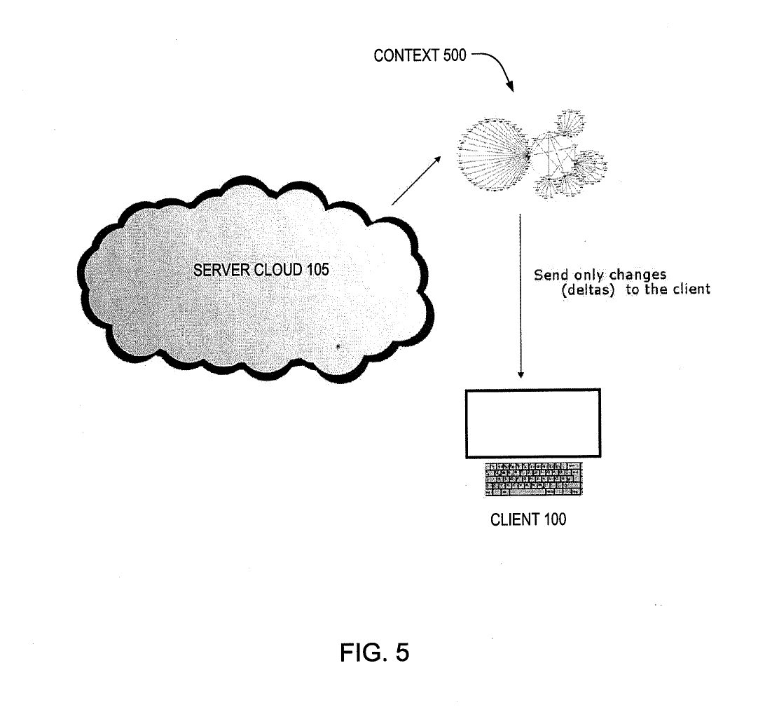

FIG. 5 illustrates an example of rendering visualization images in a server cloud. Since the context of the image is maintained in the cloud, only changes are sent to the client.

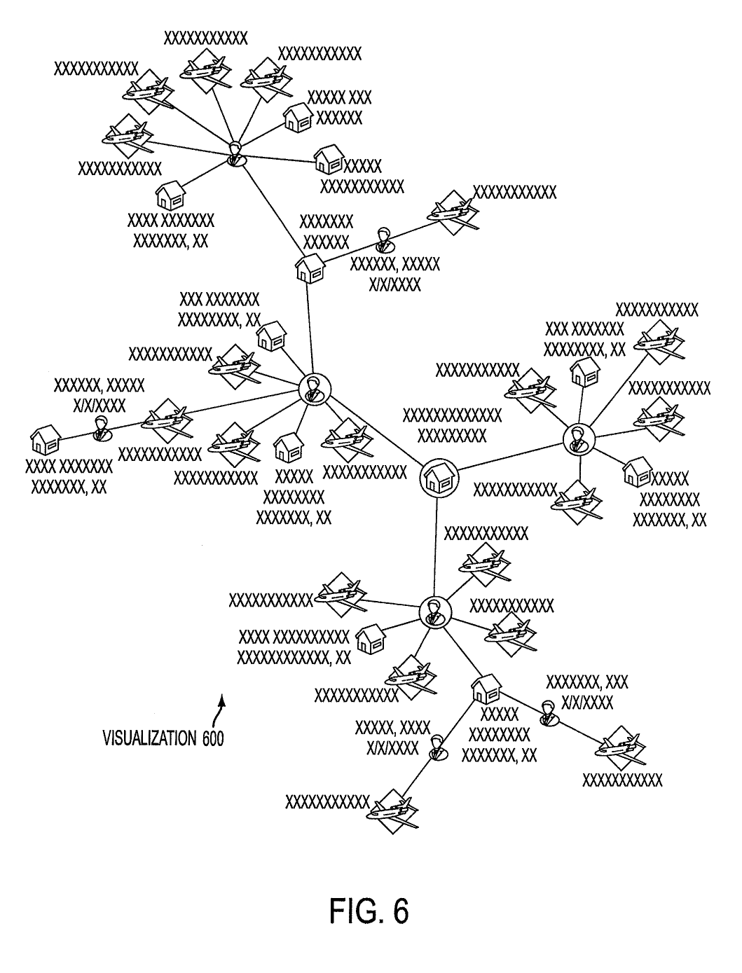

FIG. 6 illustrates an example of an interactive visualization relating to people, places and flights. For example, FIG. 6 depicts a link analysis diagram showing individuals, addresses and airline flights. Note that some of the elements in the picture are highlighted (or selected). The act of selecting these specific elements in the visualization provides an example of interactivity. Rather than simply providing a picture, the system maintains some awareness (context) of the interactions with specific elements therein through the communication between the client and the server.

For example, consider the case of dragging a particular node on a graph as shown in FIG. 6. Remembering the client has received only a rendered image from the server, the client has no context for the individual data elements that are depicted. However, a user can indicate an interest in dragging a node by moving a mouse cursor, for example, until it was directly over the node of interest. The user can then select, or click down on, the node to initiate the drag. This selection can then be sent to the server cloud in real-time. The cloud can determine that the user selected a particular node; for example a person in the displayed visualization.

It should be appreciated that the client is not limited to receiving user interface commands from the user via a mouse. Rather, any suitable mechanism may be used to receiving user interface commands from the user, such as a touch sensitive display responsive to touches by one or more of the user's fingers, for example.

In response to the cloud determining that the user has selected a particular node in the visualization:
1. The server cloud can send a new image portion to the client with the node of interest removed.
2. The server cloud can send instructions to the client to dynamically create an icon representing the person and have it track and subsequent mouse movements.
3. The client can move the newly created icon in accordance with the drag performed by the user.
4. When the mouse button is release, the client can send the new positions to the server.
5. The server cloud can update the relevant portion of the image accordingly and sends it back to the client.

It should be noted that the present invention provides for extremely efficient network transmission so the net effect as perceived by the user is a seamless move of a node from one location to another.

The interactions that the client can perform include, but are not limited to:
move or drag individual elements
select individual elements for subsequent operations
annotate the graph (text, drawings, video, etc.)
zoom in and out
add nodes, links or other graph elements
perform operations such as filtering, grouping, clustering, etc; these are operations relating to the actual data behind the visualization, and
drill-down into particular graph elements for further details; for example, drilling down into a state to see metrics by city.

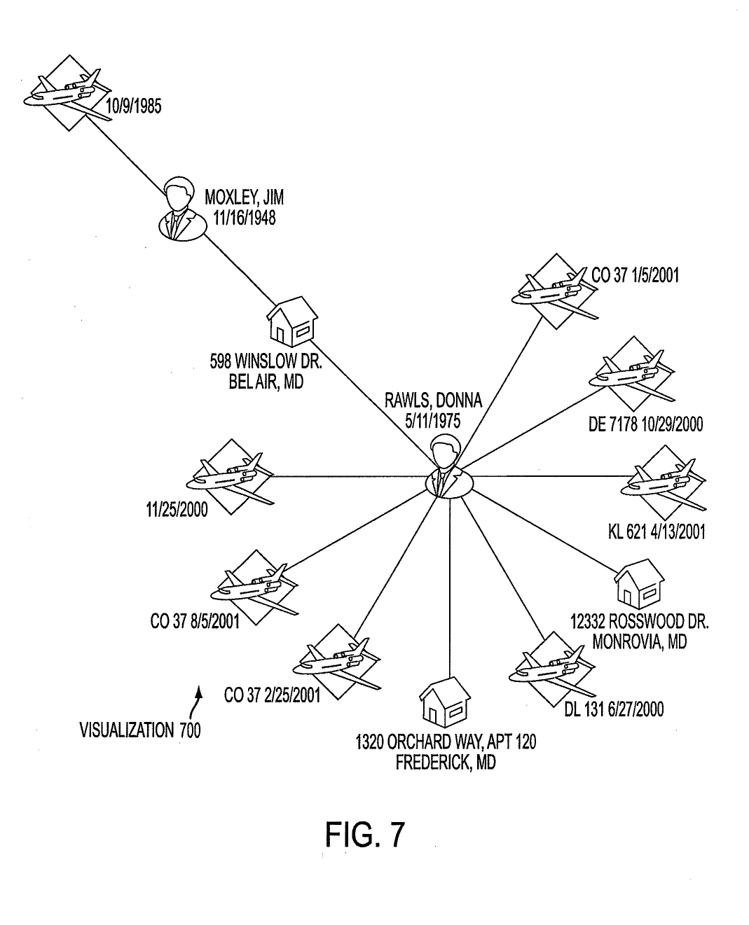

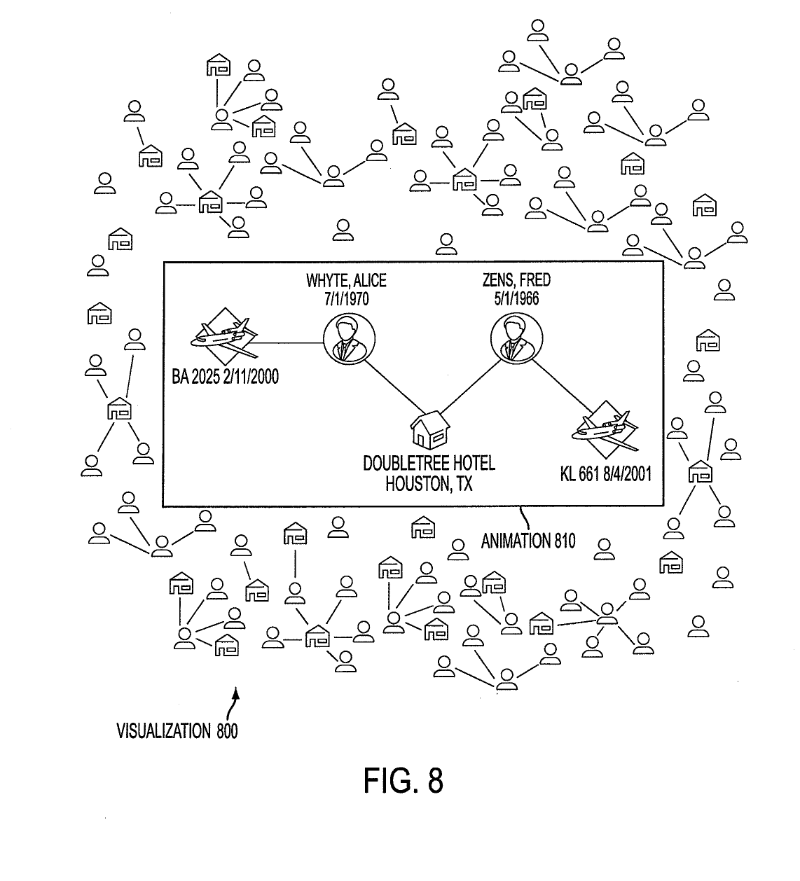

FIG. 7 illustrates another example of a link analysis diagram visualization depicting people, places and flights. To make this interactive, for example, the client computer can provide a user with the ability to click on individual people in the graph and drill down to more data, or move them to another location on the graph. FIG. 8 also illustrates an example of a dynamic element-based image animation.

The client and server computers described above can be any suitable type of microprocessor-based device and include any suitable type of programming to embody the functionality described in the various embodiments disclosed above. For example, the servers could be standard PCs running the Linux operating system with standard Java-based application servers. The client could be a standard personal computer running Microsoft Windows.

The programming can be stored and/or transported within any computer-readable storage medium for use by or in connection with an instruction execution system, apparatus, or device that can fetch instructions associated with the software from the instruction execution system, apparatus, or device and execute the instructions. In the context of this document, a computer-readable storage medium can be any medium that can contain or store programming for use by or in connection with an instruction execution system, apparatus, or device.

The programming can also be propagated within any transport medium for use by or in connection with an instruction execution system, apparatus, or device that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A server computer system configured to:
receive over a network from a client computer a request for a visualization of data elements;
render the visualization in response to the request, the rendering including
accessing a data structure storing the data elements, and
processing the accessed data elements according to the request using multiple server computers; and
send to the client computer over the network the rendered visualization in a format displayable by the client computer without access to the data structure.

2. A server computer system configured to:
store a context of a visualization of data elements provided to a client computer;
receive from the client computer a request for interaction associated with one of the data elements associated with the visualization;
send to the client computer instructions to animate the data element to achieve the interaction;
receive from the client computer an end state associated with the interaction;
apply the end state to the context of the visualization; and
send to the client computer changes to the visualization to reflect the end state.
